(19) United States
(12) Patent Application Publication
(10) Pub. No.: US 2020/0229484 A1
(43) Pub. Date: Jul. 23, 2020

(54) Instant Food

(71) Applicant: General Mills, Inc., Minneapolis, MN (US)

(72) Inventors: David J. Domingues, Plymouth, MN (US); Karin C. Gaertner, Andover, MN (US); Amy N. Homuth, Plymouth, MN (US)

(73) Assignee: General Mills, Inc., Minneapolis, MN (US)

(21) Appl. No.: 16/737,492

(22) Filed: Jan. 8, 2020

Related U.S. Application Data
(60) Provisional application No. 62/793,613, filed on Jan. 17, 2019.

(51) Int. Cl. A23P 10/47; A23L 29/10; A23L 29/281; A23L 29/30; A23L 9/10

(52) U.S. Cl. CPC A23P 10/47; A23L 29/10; A23V 2002/00; A23L 29/30; A23L 9/10; A23L 29/281

(57) ABSTRACT

A method includes making a food by combining a dry food mix with a liquid and stirring by hand for less than 5 minutes to achieve a food. A dry food mix described includes a pregelatinized starch and a whipping base that includes an emulsifier, an emulsion stabilizer, and a whipping aid.

### CROSS-REFERENCE TO RELATED APPLICATIONS

This application claims the benefit of U.S. Provisional Patent Application Ser. No. 62/793,613, which was filed on Jan. 17, 2019 and titled “Instant Food”. The entire content of this application is incorporated by reference.

### BACKGROUND

Instant food products provide consumers a quick way to make a food with little effort and/or time. Instant food products differ from ready-to-eat food products in that they require some preparation to make the desired product, but generally do not require as much preparation as a similar product made from scratch. Instant food products often provide more flexibility than a ready-to-eat food product because they often have a longer shelf life than similar ready-to-eat food products, and consumers can decide when to make them and how much to make at once. Thus, there is a need for new varieties of instant food products to meet consumer needs.

### SUMMARY

The present disclosure relates to an instant food product and methods of making a food using an instant food product.

A method of making a food is provided herein. The method includes combining a liquid with a dry food mix at a ratio of about 2:1 to about 3:1 liquid to dry food mix on a weight basis to produce a mixture, stirring the mixture by hand for less than 3 minutes to achieve a composition; and chilling the composition to produce the food. The dry food mix includes 15-30% by weight pregelatinized starch, and an amount of whipping base sufficient to achieve a test viscosity of at least 60,000 cP with 700 Joules mixing energy input per kg dry food mix plus liquid over 60 seconds, where the whipping base includes an emulsifier, an emulsion stabilizer, and a whipping aid.

In some embodiments of a method provided herein, the liquid comprises a milk product.

In some embodiments of a method provided herein, the chilling step is less than 10 minutes.

In some embodiments of a method provided herein, the stirring step includes a first stirring interval of at least 45 seconds, a resting interval of less than 1 minute, and a second stirring interval of at least 45 seconds.

In some embodiments of a method provided herein, the dry food mix includes 17-21% by weight pregelatinized starch.

In some embodiments of a method provided herein, the whipping base is included in an amount of from 5% to 25% by weight of the dry food mix.

In some embodiments of a method provided herein, the emulsifier comprises sodium caseinate or tetrasodium pyrophosphate. In some embodiments of a method provided herein, the emulsion stabilizer comprises propylene glycol monostearate or mono- and diglycerides. In some embodiments of a method provided herein, the whipping aid comprises acetylated monoglycerides or propylene glycol monostearate.

In some embodiments of a method provided herein, the dry food mix comprises a thickener. In some embodiments, the thickener comprises a protein, a fat, a gum, cocoa, or tetrasodium pyrophosphate.

In some embodiments of a method provided herein, the dry food mix includes 45-60% by weight sugar.

These and various other features and advantages will be apparent from a reading of the following detailed description.

### DETAILED DESCRIPTION

The present disclosure relates to a dry food mix that can be combined with a liquid and hand stirred to provide a unique food product that is less dense than an instant pudding product. The dry food mix provided herein provides a benefit of being able to be made by a consumer without the need for an electric mixer, and with minimal time. Further, because the dry food mix provided herein requires mixing for only a short time by hand, the food needs less cooling time after mixing to achieve a desired texture and temperature for eating.

As used herein, a dry food mix refers to a combination of powdered ingredients that are shelf stable in moisture-resistant packaging. A dry food mix is generally combined with a liquid before consumption.

A dry food mix provided herein is used in a method of making a food. A method of making a food includes combining a liquid with a dry food mix at a ratio of about 2:1 to about 3:1 (e.g., about 2.5:1) liquid to dry food mix on a weight basis to produce a mixture.

Liquids suitable for use in a method of making a food provided herein include, for example, water, a dairy-based milk product (e.g., whole, skim, or part skim milk, cream, half-and-half, kefir, or other milk product from a cow, goat, horse, sheep, or the like), a plant-based milk (e.g., coconut, soybean, rice, almond, oat, pea, or the like), a fruit juice, or the like.

A mixture of dry food mix and a liquid can then be stirred by hand for a period of time of less than 5 minutes (e.g., less than 4 minutes, less than 3 minutes, or about 2 minutes) to achieve a composition. Surprisingly, a method of making a food using a dry food mix provided herein requires little energy input to achieve a unique food product that is less dense than an instant pudding product, and thus does not require an electric mixer (e.g., an electric hand mixer or an electric stand mixer).

In some embodiments, a mixture can be stirred by hand for a first stirring interval, followed by a resting interval, followed by a second stirring interval, where the combined first and second stirring intervals are a period of time of less than 5 minutes (e.g., less than 4 minutes, less than 3 minutes, or about 2 minutes). A resting interval between a first and a second stirring interval can provide a benefit of first mixing a liquid and dry food mix to achieve wetting of ingredients in the dry food mix during the first stirring interval, then allowing hydration of ingredients in the dry food mix during the resting interval, then forming an aerated structure during the second stirring interval. A first stirring interval can be at least 45 seconds (e.g., 45 seconds to 2.5 minutes, or about 1 minute). A second stirring interval can be longer or shorter than a first stirring interval, and can be at least 45 seconds (e.g., 45 seconds to 2.5 minutes, or about 1 minute). A resting interval can be less than 2 minutes (e.g., less than 1 minute, or about 30 seconds).

A composition is chilled following hand stirring to achieve a set structure and a desired eating temperature. Since a method provided herein requires so little energy input to achieve a unique food product that is less dense than an instant pudding product, the composition does not heat up as much as products that require longer mixing times and/or an electric mixer. As a result, a method of making a food using a dry food mix provided herein requires little cooling to achieve a desired set structure and temperature. In some embodiments, a composition can be chilled for a period of time of less than 10 minutes (e.g., less than 7 minutes, or about 5 minutes) to achieve a desired set structure and temperature for eating.

A food product made by a method provided herein can resemble a low density pudding or a high density mousse. In addition, a food product made by a method provided herein typically takes less time and energy than commercially available instant mousse products to achieve the desired set structure.

A dry food mix provided herein includes a pregelatinized starch in an amount of from about 15% to about 30% (e.g., from about 17% to about 25%, or from about 17% to about 21%) by weight of the dry food mix. A pregelatinized starch can be from any source (e.g., corn, waxy maize, potato, wheat, tapioca, and the like). In some embodiments, a pregelatinized starch can be further modified (e.g., physically, enzymatically, or chemically) beyond being pregelatinized.

A dry food mix provided herein further includes a whipping base. A whipping base in a dry food mix provided herein includes an emulsifier, an emulsion stabilizer, and a whipping aid. An emulsifier suitable for use in a whipping base includes, for example, sodium caseinate or tetrasodium pyrophosphate, or combinations thereof. An emulsion stabilizer suitable for use in a whipping base includes, for example, propylene glycol monostearate or mono- and diglycerides, or combinations thereof. A whipping aid suitable for use in a whipping base includes, for example, comprises acetylated monoglycerides or propylene glycol monostearate, or combinations thereof. In some embodiments, one or more of an emulsifier, an emulsion stabilizer, and a whipping aid can be included in a dry food mix provided herein as part of a whipping base premix and/or part of other ingredients (e.g., a powdered dairy ingredient) included in the dry food mix.

The amount of whipping base in a dry food mix provided herein can be determined by measuring the “test viscosity,” and is sufficient to achieve a test viscosity of at least 60,000 cP with 700 Joules mixing energy input per kg of a mixture of a dry food mix plus a liquid. As used herein, the “test viscosity” is measured by combining 45 g dry food mix including the whipping base with 110 g liquid 2% cow's milk at refrigeration temperature. The combined dry food mix and liquid (i.e., whole milk) is then mixed at room temperature at a speed of 220 rpm using Cole-Palmer Instrument company servodyne mixer head model 50003-30 and mixer control model 50003-00 equipment with a 4.2 cm radius tri-blade mixing element/shaft to simulate hand mixing. The energy draw on the mixer is measured over a period of 60 seconds using, e.g., a Watts Up Pro watt meter (Vernier Software & Technology, Beaverton, Oreg., USA). At the end of 60 seconds of mixing, the test viscosity of the mixed dry food mix and liquid is measured using a Brookfield DV-II viscometer fitted with a LV-3 spindle at 10 rpm at 5-10° C. An amount of whipping base suitable for use in a dry food mix ranges from about 4% to about 25% (e.g., from about 4.5% to about 15%) by weight of the dry food mix.

In some embodiments, a dry food mix provided herein further includes a thickener. Suitable thickeners include, for example, a protein, a fat, a gum, cocoa, or tetrasodium pyrophosphate, or combinations thereof. In some embodiments, a thickener can include a powdered dairy product, such as a cheese, cream cheese, or a yogurt. A thickener can be included in a dry food mix provided herein in an amount of up to about 20% (e.g., from about 5% to about 20%) by weight of the dry food mix. In some embodiments, cocoa, which can also act as a flavorant, can be included in an amount of up to about 15% (e.g., from about 8% to about 12%) by weight of the dry food mix.

In some embodiments, a dry food mix provided herein further includes a sweetener. Any dry sweetener can be used in a dry food mix. Examples of dry sweeteners include sugars (e.g., sucrose, dextrose, fructose, powdered honey, powdered syrup, and the like), and sugar substitutes (e.g., sugar alcohols, sucralose, stevia and its derivatives, aspartame, and the like). Sugars and other sweeteners that are not high-intensity sweeteners (e.g., sugar alcohols) can be included in a dry food mix in an amount of from about 45% to about 60% (e.g., about 47% to about 55%) by weight of the dry food mix. High-intensity sweeteners (e.g., sucralose, aspartame, stevia and its derivatives, saccharin, Ace-K, and the like) can be included in a dry food mix in an amount of less than 2% (e.g., 0.001% to 0.5%) by weight of the dry food mix. Generally, bulking agents are also included in a dry food mix when a high intensity sweetener is used. For example, an oat fiber or a citrus fiber can be used as a bulking agent with a high intensity sweetener.

In some embodiments, a cellulose (e.g., carboxymethyl cellulose, microcrystalline cellulose, and the like) or a gum (e.g., xanthan gum) can be included in a dry food mix. A cellulose or a gum can contribute to shear thinning during stirring and/or contribute to setting of the structure of a food made from the dry food mix upon resting. A cellulose can be included in a dry food mix provided herein in an amount of about 0.5% to about 2.5% by weight of the dry food mix. A gum can be included in a dry food mix provided herein in a amount of about 0.2% to about 2% by weight of the dry food mix.

Other ingredients, such as anti-caking ingredients (e.g., silicon dioxide), flavorants (e.g., natural or artificial flavors, cocoa, salt, and the like), colorants (e.g., natural or artificial colors, titanium dioxide, and the like), flavor enhancers (e.g., citric acid), dusting agents (e.g., powdered oils), flow agents (e.g., dextrose), or the like can be included in a dry food mix provided herein. Other ingredients can be included in a dry food mix provided herein in an amount of up to 20% (e.g., from about 1% to about 18%) by weight of the dry food mix.

### EXAMPLES

### Example 1

An inventive chocolate dry food mix, including 16-22% pregelatinized starch, 4-10% of a whipping base (including tetrasodium pyrophosphate, propylene glycol monostearate, mono- and diglycerides, sodium caseinate, and acetylated monoglycerides), 2-4% a powdered dairy thickener (cream cheese blend), 8-12% cocoa, 48-58% sucrose, and 11-20% other ingredients (salt, dextrose, microcrystalline cellulose, sodium carboxymethylcellulose, locust bean gum, buttermilk, corn syrup solids, canola oil, palm kernel oil). Test viscosity measurement, as described above, was performed on the chocolate dry food mix, and compared to a commercial chocolate mousse product (Double Chocolate Mousse Supreme by Dr. Oetker, Dr. Oetker USA LLC, Mount Laurel, N.J., USA) treated in the same manner to measure the test viscosity. Table 1 shows representative test viscosities for a dry food mix according to the invention as compared to the commercial chocolate mousse product.

TABLE 1

| | Energy input at 60 seconds | Viscosity |
|---|---|---|
| Product | (Joules/kg) | (Cp) |
| Inventive dry | 700 | 98500 |
| food mix | | |
| Commercial chocolate | 735 | 50400 |
| mousse product | | |

As can be seen in Table 1, the test viscosity of the inventive dry food mix was nearly twice as high as compared to the commercial chocolate mousse product.

### Example 2

An inventive chocolate dry food mix as described in Example 1 was combined with various liquids at a ratio of 90 g dry food mix to 1 cup liquid (liquid weight varied, depending on the liquid used), then stirred at a moderate pace by hand using a spoon for 30 seconds, allowed to rest at room temperature for 1 minute, then stirred by hand for another 30 seconds. Following the second stirring interval, the product temperature was measured, and the product was allowed to rest at room temperature for 20 minutes. The viscosity was then measured using a Brookfield DV-II viscometer fitted with an E spindle at 20 rpm at the temperature of the product (ranged from 55-63° F.), with viscosity measurements taken at 10, 20, and 30 seconds, and averaged to determine viscosity. The commercial chocolate mousse product described in Example 1 was treated in the same manner, and the temperature and viscosity were measured. A commercial chocolate pudding product (Jell-O® Instant Chocolate Fudge Pudding & Pie Filling, Kraft Heinz Company, USA) was treated in the same manner, except that 110 g mix and 2 cups 2% homogenized milk was used to be consistent with the manufacturer's instructions, and the temperature and viscosity were measured.

Using dairy milk products (2% homogenized milk, and ultrafiltered whole milk) as the liquid, the inventive chocolate dry food mix had a viscosity prior to the 20 minute rest period of about 15000-17000 cP, which increased to about 50000-90000 cP after the 20 minute rest period. Using non-dairy milk products (coconut milk, soy milk, and almond milk) as the liquid, the inventive chocolate dry food mix had a viscosity prior to the 20 minute rest period of about 23000-61000 cP, and was at 40000-55000 cP after the 20 minute rest period. Using water as the liquid, the inventive chocolate dry food mix had a viscosity prior to the 20 minute rest period of about 21000-23000 cP, and a viscosity of about 25000-30000 cP after the 20 minute rest period.

Using dairy milk products (2% homogenized milk, and ultrafiltered whole milk) as the liquid, the commercial chocolate mousse product had a viscosity prior to the 20 minute rest period of about 9000-22000 cP, which increased to about 21000-38000 cP after the 20 minute rest period. Using non-dairy milk products (coconut milk, soy milk, and almond milk) as the liquid, the commercial chocolate mousse product had a viscosity prior to the 20 minute rest period of about 10000-22000 cP, and a viscosity of about 18000-32000 cP after the 20 minute rest period. Using water as the liquid, the commercial chocolate mousse product had a viscosity prior to the 20 minute rest period of about 3000 cP, and a viscosity of about 5500-7000 cP after the 20 minute rest period.

Using 2% homogenized dairy milk as the liquid, the commercial chocolate pudding product had a viscosity prior to the 20 minute rest period of about 26000 cP (as compared to about 16000 cP for the inventive dry food mix), which increased to about 47000 cP after the 20 minute rest period (as compared to about 55000 cP for the inventive dry food mix).

These results indicate that the inventive dry food mix produces a food when mixed with a liquid by hand that is more viscous than the commercial chocolate mousse product. These results also show that the inventive dry food mix is less viscous than the comparative commercial chocolate pudding product before a resting period, but becomes slightly more viscous after the resting period.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A method of making a food, the method comprising:
a. combining a liquid with a dry food mix at a ratio of about 2:1 to about 3:1 liquid to dry food mix on a weight basis to produce a mixture, the dry food mix including
i. 15-30% by weight pregelatinized starch, and
ii. an amount of whipping base sufficient to achieve a test viscosity of at least 60,000 cP with 700 Joules mixing energy input per kg dry food mix plus liquid over 60 seconds, the whipping base including an emulsifier, an emulsion stabilizer, and a whipping aid;
b. stirring the mixture by hand for less than 3 minutes to achieve a composition; and
c. chilling the composition to produce the food.

2. The method of claim 1, wherein the liquid comprises a milk product.

3. The method of claim 1, wherein the chilling step is less than 10 minutes.

4. The method of claim 1, wherein the stirring step includes a first stirring interval of at least 45 seconds, a resting interval of less than 1 minute, and a second stirring interval of at least 45 seconds.

5. The method of claim 1, wherein the dry food mix includes 17-21% by weight pregelatinized starch.

6. The method of claim 1, wherein the emulsifier comprises sodium caseinate or tetrasodium pyrophosphate.

7. The method of claim 1, wherein the emulsion stabilizer comprises propylene glycol monostearate or mono- and diglycerides.

8. The method of claim 1, wherein the whipping aid comprises acetylated monoglycerides or propylene glycol monostearate.

9. The method of claim 1, wherein the whipping base is included in an amount of from 5% to 25% by weight of the dry food mix.

10. The method of claim 1, wherein the dry food mix comprises a thickener.

11. The method of claim 11, wherein the thickener comprises a protein, a fat, a gum, cocoa, or tetrasodium pyrophosphate.

12. The method of claim 1, wherein the dry food mix includes 45-60% by weight sugar.
